(19) United States
(12) Patent Application Publication
(10) Pub. No.: US 2020/0010731 A1
(43) Pub. Date: Jan. 9, 2020

(54) Wrap

(71) Applicant: Reel Grip, Ltd., Wadsworth, OH (US)

(72) Inventors: Angelo N. Savakis, Chagrin Falls, OH (US); Daniel E. Broadbent, Chagrin Falls, OH (US); Curtis Ray Adkins, JR., Tucson, AZ (US)

(21) Appl. No.: 16/505,158

(22) Filed: Jul. 8, 2019

Related U.S. Application Data
(60) Provisional application No. 62/695,532, filed on Jul. 9, 2018.

(51) Int. Cl. C09J 7/38; A01K 87/08; B29C 43/00; B29C 43/32; C09J 7/24; C09J 7/40; C09J 5/00

(52) U.S. Cl. CPC C09J 7/38; A01K 87/08; B29C 43/003; B29C 43/32; B29L 2007/007; C09J 7/40; C09J 5/00; B29K 2905/12; C09J 7/243

(57) ABSTRACT

In accordance with an example embodiment, there is disclosed herein a strip of self-fusing silicon for providing a wrap. The strip has a top surface and a bottom surface. The top surface comprises sides and textured surfaces. Another embodiment includes a method comprised of molding self-fusing silicone. Another embodiment includes a strip of self-fusing silicone that includes a top side comprised of a textured surface which is prepared by a process comprising the steps of molding the self-fusing silicone and cutting the self-fusing silicone into at least one strip of self-fusing silicone.

### CROSS-REFERENCE TO RELATED APPLICATIONS

This application claims priority to provisional application No. 62/695,532, filed on Jul. 9, 2018, which is incorporated herein by reference.

### TECHNICAL FIELD

The present disclosure relates generally to a wrap that can be employed as a grip for handles such as, for example, fishing rods.

### BACKGROUND

The ability to grasp an object is important when using sports equipment and/or when working with certain hand tools. Securely grasping equipment and/or tools so that they do not slip helps to ensure proper use. Specifically, the ability to firmly grip an item, such as a fishing rod, club, bat, or racket handle enhances the ability of a user to use the item.

### SUMMARY OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a strip of a self-fusing silicon for providing a wrap that can be employed as a grip. The strip has a top surface and a bottom surface. The top surface comprises sides and textured surfaces separated by grooves.

In accordance with an example embodiment, there is disclosed herein a fishing rod comprising in combination a handle and a wrap secured to the handle wherein the wrap is comprised of self-fusing and molded silicone or silicone rubber comprised of a textured surface.

In accordance with an example embodiment, there is disclosed herein a method comprising molding self-fusing silicone and securing the self-fusing silicone to a handle of an item such as a grip or wrap. The method employs molding which allows for textured surfaces.

In accordance with an example embodiment, there is disclosed herein a strip of self-fusing silicone which includes a top side comprised of a textured surface which is prepared by a process comprising the steps of molding the self-fusing silicone and cutting the self-fusing silicone into at least one strip of self-fusing silicone

### BRIEF DESCRIPTION OF THE DRAWINGS

The accompanying drawings incorporated herein and forming a part of the specification illustrate the example embodiments.

FIG. 1 is a top view of an example of a strip for implementing a wrap in accordance with an example embodiment.

FIG. 2 is a view along a transverse axis of the strip illustrated in FIG. 1.

FIG. 3 is an expanded view of the strip illustrated in FIG. 2.

FIG. 4 is a view along the longitudinal axis of the strip illustrated in FIG. 1.

FIG. 5 is an example exploded view of a textured pattern on the top surface of the strip illustrated in FIG. 1.

FIG. 6 is a side view of an example of a wrap secured to a handle of a fishing rod.

FIG. 7 is a block diagram illustrating an example of a method for making a wrap.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described herein is an example of a strip 2 as well as the method and compound specification for a wrap 4 that is suitable for use as a fishing rod wrap 6. The wrap 4 is comprised of self-fusing silicone or silicone rubber 8 that is molded and provides the ability to create unique surface patterns. Also the wrap 4 described herein is solid silicone whereas other products on the market for the fishing industry are a form of foam rubber. In an example embodiment, the material for the strip 2 is silicon rubber with a hardness within a range of 15-25 Shore A as measured on the Shore A hardness scale, and in particular embodiments the hardness is 20 Shore A as measured on the Shore A hardness scale.

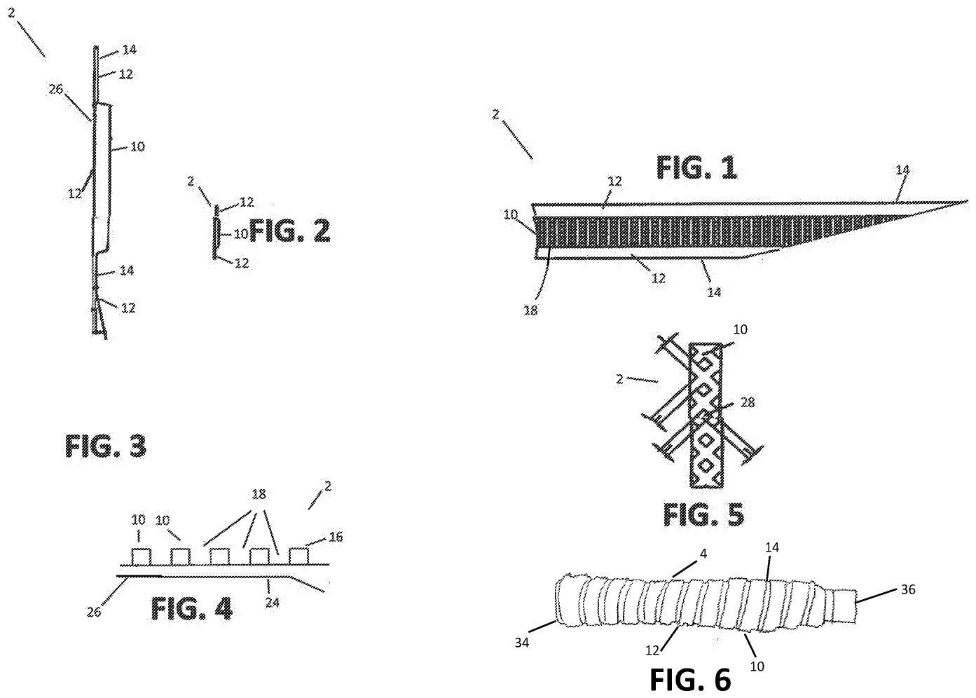

FIG. 1 is a top view of a strip 2 for implementing a grip in accordance with an example embodiment. The strip 2 comprises a textured surface 10 in the center of the strip and polished surfaces 12 on each side 14 of the textured surface 10. In an example embodiment (as depicted in FIG. 4), the top surface 16 further comprises grooves 18 between the textured surfaces 10.

FIG. 2 is a view along a transverse axis 20 of the strip 2 illustrated in FIG. 1. FIG. 3 is an expanded view of FIG. 2 illustrating the location of polished surfaces 12, including on the bottom 26 of the strip 2.

FIG. 4 is a view along the longitudinal axis 22 of the strip 2 illustrated in FIG. 1. In the illustrated example, textured surfaces 10 and grooves 18 are located at the top of the strip 2. A peel away backing 24 may be deployed on the bottom 26 of the strip 2 to prevent the strip 2 from sticking to itself prior to deploying the strip 2.

FIG. 5 is an example an exploded view of a textured pattern 10 on the top surface 16 of the strip 2 illustrated in FIG. 1. The textured pattern 10 comprises raised (or highlighted) surfaces 28 that are shaped as squares (or partial squares at the edges) tilted at a forty-five-degree angle. In particular embodiments, the space 30 between the raised surfaces 28 is concave as illustrated in FIG. 5. Those skilled in the art can readily appreciate that the raised surfaces 28 and the spaces 30 may be any desired surface or shape.

To employ the strip 2 onto a surface 32 of an article (for example, a handle of a fishing rod, athletic equipment, tools, etc.), the peel away backing 24 should be removed from the strip 2, and the strip 2 wrapped around the surface 32 of the article. The self-fusing silicone rubber will form a permanent bond and no adhesive is needed.

FIG. 6 illustrates an example of a side view of a wrap 4 secured to a handle 34 of a fishing rod 36. The wrap 4 is molded and is comprised of self-fusing silicone 8.

In an example embodiment, a compound 38 for a strip 2 comprises the following:

5 parts silicone gel;

50 parts of a 20 durometer base;

1 part pigment for non-translucent products (conversely, for translucent products no pigment is utilized)

40 parts tack agent, such as Reisen B (if a pigment is utilized then 39 parts tack agent are utilized);

2 parts peroxide (or equivalent curing package); and

3 parts ultraviolet stabilizer.

Although the compound is not limited to use of such, a suitable silicone gel and 20 durometer base are available from Wacker Chemical Corporation, located at 2215 International Pkwy, Canton, Ohio 44720, with a website of: https://www.wacker.com/cms/en/home/index.jsp.

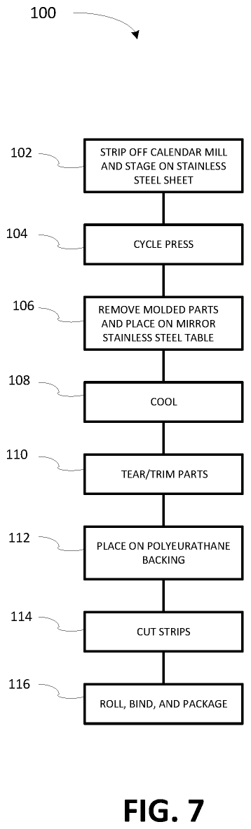

In view of the foregoing structural and functional features described above, a methodology 100 for manufacturing a wrap 4 in accordance with an example embodiment is illustrated in FIG. 7. While, for purposes of simplicity of explanation, the methodology of FIG. 7 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment.

A method for molding the compound 38 includes the following:

tonnage—180-ton pressure (for example, using a 350-ton press);

cure time—8 minutes;

temperature—265 degrees Fahrenheit;

bottom mold cavity area—0.1 um roughness average (Ra); and

stainless steel cooling table—0.1 um Ra

where Ra is a measurement of surface roughness in micro-meters.

At 102 of FIG. 7, the compound 38 is stripped off a calendar mill and staged on stainless steel sheets. In the example illustrated herein, the compound 38 is stripped at dimensions of 0.5″ width, 0.1″ thickness, and 27″ length.

At 104 of FIG. 7, one strip 2 of the compound 38 is placed per cavity and cycle-pressed. At 106 of FIG. 7, the molded parts 40 are moved and, at 108 of FIG. 7, placed on a mirror finish stainless steel table to cool. In an example embodiment, the molded parts 40 are cooled for six minutes.

After cooling, at 110 of FIG. 7, the molded parts 40 are torn and/or trimmed, and, at 112 of FIG. 7, the molded parts 40 are placed onto a polyethylene film. At 114 of FIG. 7, the molded parts 40 are cut into strips 2. At 116 of FIG. 7, the strips 2 are rolled and bound. In an example embodiment, at least one strip 2 is packaged for sale. In at least one embodiment, the strip 2 is secured to a handle 34 of an apparatus, including a handle 34 of a fishing rod 36.

As those skilled in the art can readily appreciate, because the strip 2 is molded, this provides the ability to use patterns for the texture 10 on the top surface 16 of the strip 2 that cannot otherwise be formed by using extrusion. Because the strip 2 employs a self-fusing material 8, no adhesives are required.

In an example embodiment, a strip 2 of self-fusing silicone includes a top side 16 comprised of a textured surface 10 with raised surfaces and spaces between at least some of the raised surfaces, which is prepared by a process comprising the steps of molding the self-fusing silicone and cutting the self-fusing silicone into at least one strip 2 of self-fusing silicone.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally, and equitably entitled.

What is claimed is:

1. A wrap comprising a strip wherein such strip is comprised of molded, self-fusing silicone and a top surface of such strip of such molded, self-fusing silicone comprises a textured surface.

2. The wrap of claim 1 wherein such textured surface comprises raised surfaces and spaces between at least some of such raised surfaces.

3. The wrap of claim 1 further comprising a handle of a fishing rod wherein such wrap is secured to such handle.

4. The wrap of claim 1 wherein such molded, self-fusing silicone has a hardness within a range of 15-25 Shore A on the Shore A hardness scale.

5. The wrap of claim 1 wherein such molded, self-fusing silicone has a hardness within a range of 20 Shore A on the Shore A hardness scale.

6. The wrap of claim 1 wherein a peel away backing is affixed to a bottom side of such strip of molded, self-fusing silicone.

7. The wrap of claim 2 wherein such textured surface also comprises grooves.

8. The wrap of claim 2 wherein such raised surfaces are substantially shaped as squares, other than at the edges of such textured surface.

9. The wrap of claim 8 wherein such textured surface is located in a center of such top surface of such strip of molded, self-fusing silicone

10. The wrap of claim 9 wherein at least one side of such top surface of such strip of molded, self-fusing silicone is polished.

11. A method comprising:
molding a self-fusing silicone;
stripping the compound comprised of the self-fusing silicone off of a calendar mill;
staging the compound on at least one stainless steel sheet;
cycle-pressing the compound;
placing the compound on a stainless steel table;
trimming the compound;
placing the compound onto a polyethylene film; and
cutting the compound into at least one strip of the self-fusing silicone.

12. The method of claim 11 wherein the self-fusing silicone is molded such that a top surface of the self-fusing silicone comprises a textured surface comprised of raised surfaces and spaces between at least some of the raised surfaces.

13. The method of claim 11 further comprising securing the self-fusing silicone to a handle of an item.

14. The method of claim 12 wherein the raised surfaces are substantially shaped as squares, other than at the edges of the textured surface.

15. The method of claim 13 wherein the item is a fishing rod.

16. A strip of self-fusing silicone wherein a top side of such strip of self-fusing silicone comprises a textured surface with raised surfaces and spaces between at least some of such raised surfaces, prepared by a process comprising the steps of molding such self-fusing silicone and cutting such self-fusing silicone into at least one strip of self-fusing silicone.
